(19) United States
(12) Patent Application Publication
(10) Pub. No.: US 2008/0264492 A1
(43) Pub. Date: Oct. 30, 2008

(54) Methods for pressurizing boil off gas

(76) Inventors: Hyun Cho, Katy, TX (US); Felix J. Fernandez de la Vega, Houston, TX (US)

Correspondence Address: KELLOGG BROWN & ROOT LLC;ATTN: Christian Heausler, 4100 Clinton Drive, HOUSTON, TX, 77020, US

(21) Appl. No.: 11/646,875

(22) Filed: Dec. 28, 2006

(51) Int. Cl. B23P 17/00

(52) U.S. Cl. 137/14

(57) ABSTRACT

A method for pressurizing vapor from a liquefied gas is provided. At least a portion of a storage tank overhead vapor stream can flow to an eductor and at least a portion of a hydrocarbon liquid stream can flow to the eductor. The hydrocarbon liquid stream can have a higher pressure than the vapor stream. The vapor stream and the hydrocarbon liquid stream can be combined within the eductor to provide a mixed stream. The mixed stream can be pressurized within the eductor.

### BACKGROUND

1. Field

Embodiments herein generally relate to methods for pressurizing boil off gas. More particularly, the embodiments relate to methods for pressurizing boil off gas through an eductor.

2. Description of the Related Art

Liquid geologically-extracted hydrocarbons are referred to as petroleum or mineral oil, while gaseous geologic hydrocarbons are referred to as natural gas. All are significant sources of fuel and raw materials. Certain hydrocarbons undergo purification and liquefaction to be stored for later use. During liquefaction, the hydrocarbons are cooled to a liquid state below their critical temperature and pressure.

Liquefaction involves a number of processes occurring at specialized facilities such as liquefaction plants and import terminals. At liquefaction plants and import terminals, high pressure liquid hydrocarbons such as liquefied natural gas (LNG), liquefied petroleum gas (LPG), and other aromatic hydrocarbons often lose significant amounts of hydrocarbon vapor and low pressure liquid hydrocarbons. Since the vapor is a gaseous result of adding heat to the liquid hydrocarbon, the vapor is often referred to as boil-off gas (BOG). Typically, BOG results from heat added to the liquid hydrocarbon by heat flux through walls of associated piping systems and storage tanks to produce a vapor. The resulting vapor is then normally pressurized by compressors and routed to a recondenser where it is mixed with sub-cooled LNG pressurized by pumps.

FIG. 1 depicts an illustrative prior art system for compressing and handling liquefied natural gas at import terminals. The system requires a hydrocarbon storage tank 10 with an in-tank pump 15, a vapor compressor 20, a recondenser 30, a booster pump 40, and a vaporizer 50. A vapor stream containing the BOG from the liquid stored within the storage tank 10 is compressed with the compressor 20. The recondenser 30 is used to condense the compressed vapor stream to a liquid which is mixed with the liquefied gas from the in-tank pump 15. The booster pump 40 and vaporizer 50 are then used to distribute a vaporized product for end use.

A need exists for an improved method for direct condensation and pressurization of both the vapor and liquid phases of a liquefied gas.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope, for the embodiments may admit to other equally effective embodiments.

FIG. 1 depicts an illustrative prior art system for compressing and handling liquefied natural gas at import terminals.

FIG. 2 depicts an illustrative system for pressurizing a hydrocarbon with an eductor according to one or more embodiments.

FIG. 3 depicts an illustrative eductor according to one or more embodiments.

FIG. 4 depicts another illustrative system for pressurizing a hydrocarbon with an eductor according to one or more embodiments.

FIG. 5 depicts yet another illustrative system for pressurizing a hydrocarbon with two or more eductors according to one or more embodiments.

### DETAILED DESCRIPTION

A detailed description will now be provided. Each of the appended claims defines a separate embodiment, which for infringement purposes is recognized as including equivalents to the various elements or limitations specified in the claims. Depending on the context, all references below to the “embodiment” may in some cases refer to certain specific embodiments only. In other cases it will be recognized that references to the “embodiment” will refer to subject matter recited in one or more, but not necessarily all, of the claims. Each of the embodiments will now be described in greater detail below, including specific embodiments, versions and examples, but the embodiments are not limited to these embodiments, versions or examples, which are included to enable a person having ordinary skill in the art to make and use the embodiments, when the information in this patent is combined with available information and technology.

Methods for pressurizing a hydrocarbon are provided herein. In one or more embodiments, a lower pressure hydrocarbon vapor and/or liquid can be pressurized using one or more streams of a higher pressure hydrocarbon using one or more eductors. The eductor can be used to condense and/or pressurize the lower pressure hydrocarbons without the need for additional equipment for compression and condensing. Accordingly, the methods provided can significantly reduce capital expenditure in addition to costs associated with the operation and maintenance of rotating and heat exchanging equipment. The methods provided can also be integrated into existing processing facilities with minimum re-build and construction costs.

The hydrocarbon vapor and liquid can derive from the same hydrocarbon. For example, the higher pressure hydrocarbon can be or include a liquefied gas and the lower pressure hydrocarbon can be the boil off gas (BOG) from the liquefied gas. The term “liquefied gas” as used herein refers to any gas that can be stored or transferred in a liquid phase. For example, the term “liquefied gas” includes, but is not limited to, liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof. For simplicity and ease of description, the embodiments will be further described with reference to liquefied natural gas (LNG).

With reference to the figures, FIG. 2 depicts an illustrative system 200 for pressurizing a hydrocarbon with an eductor according to one or more embodiments. In one or more embodiments, the system 200 can include one or more eductors 210 (one shown) in fluid communication with one or more storage tanks 220 (one shown) and one or more in-tank pumps 230 (“first pumps”). The eductor 210 can be adapted to mix a vapor stream 215 containing a BOG from the storage tank 220 with a liquid stream 225 (“motive stream”) to provide a mixed stream 235. The pressure of the mixed stream 235 can be increased using one or more booster pumps (“second pumps”) 260 (one shown) and vaporized within one or more vaporizers 270 (one shown). The resulting vaporized gas stream 275 can be sent to distribution or use.

The motive stream 225 can be provided to the eductor 210 via the in-tank pump 230. The in-tank pump 230 can be any submersible type pump. Such pumps are well known in the art.

Within the eductor 210, the motive stream 225 can be expanded to a pressure at or near atmospheric pressure, providing a low pressure zone within the eductor 210. The low pressure zone within the eductor 210 can create a vacuum or driving force that suctions the hydrocarbon (i.e. fluid) from the vapor stream 215. The vapor stream 215 can contact the motive stream 225 and can be mixed within the eductor 210. The mixed stream velocity can decrease through a diverging zone of the eductor 210, which converts velocity energy into pressure energy of the mixed stream 235. This can result in an increase in pressure of the mixed stream 235. The increased pressure can liquefy and sub-cool the mixed stream 235 prior to exiting the eductor 210. During this process, the hydrocarbon from the vapor stream 215 can be condensed and pressurized.

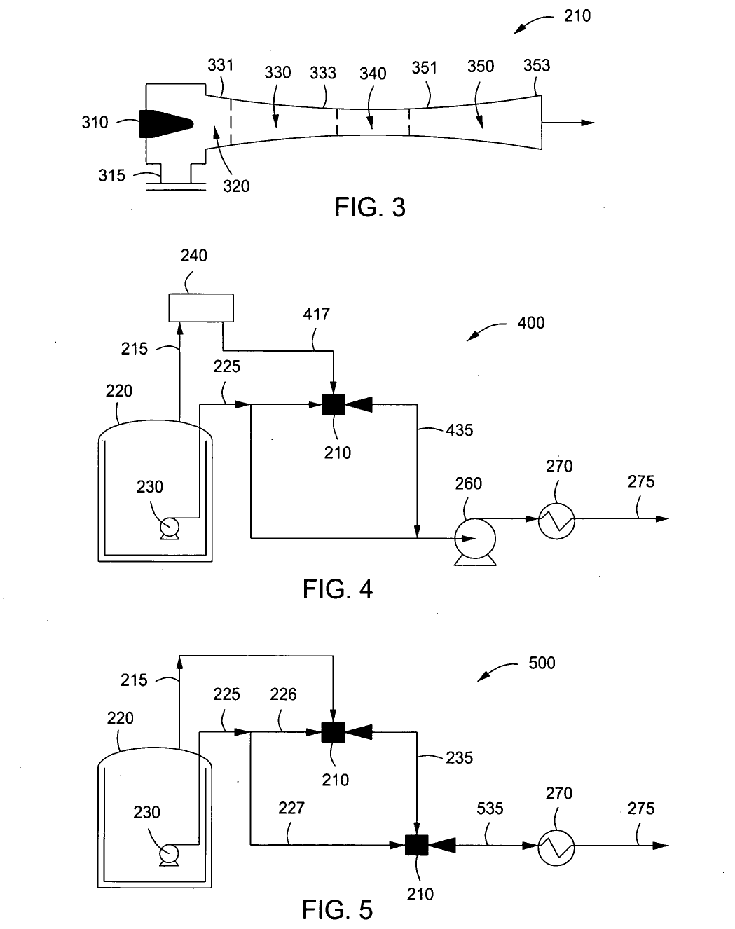

Considering the eductor 210 in more detail, FIG. 3 depicts an illustrative eductor 210 according to one or more embodiments. The eductor 210 can include a high pressure nozzle 310, suction nozzle 315, and mixing chamber 320. The mixing chamber 320 can include a first zone (“converging zone”) 330 having a gradually decreasing cross sectional area and a second zone (“diverging zone”) 350 having a gradually increasing cross sectional area. The mixing chamber 320 can further include a third zone (“throat”) 340 disposed between the converging zone 330 and diverging zone 350. The motive stream 225 enters the eductor 210 via the high pressure nozzle 310. The vapor stream 215 is in fluid communication with the eductor 210 via the suction nozzle 315.

The high pressure nozzle 310 can have a gradually reduced cross sectional area in the direction of flow. When the hydrocarbon from the motive stream 225 (“motive fluid”) flows through the high pressure nozzle 310 into the mixing chamber 320, the fluid velocity increases and the pressure decreases, adiabatically expanding the hydrocarbon (“expanded motive fluid”). Pressure energy can be converted into velocity energy during the expansion of the motive fluid across the high pressure nozzle 310. The resulting lower pressure within the mixing chamber 320 of the eductor 210 suctions the lower pressure hydrocarbon (e.g. the vapor stream 215) into the mixing chamber 320 of the eductor 210 where the suctioned hydrocarbon can be mixed with the expanded motive fluid. Motive fluid in the mixing chamber 320 can be in liquid phase or liquid/vapor phase (two phase) depending on operating conditions (i.e. temperature and pressure).

The converging zone 330 of the eductor 210 can have a cross sectional area that gradually decreases from a first end 331 thereof to a second end 333 thereof. The diverging zone 350 can have a cross sectional area that gradually increases from a first end 351 thereof to a second end 353 thereof. In operation, the converging zone 330 can increase the mixture velocity and decrease pressure of the mixture. Conversely, the diverging zone 350 can decrease the mixture velocity and increase the pressure of the mixture. The pressure increase in the diverging zone 350 can convert the mixture stream to liquid phase.

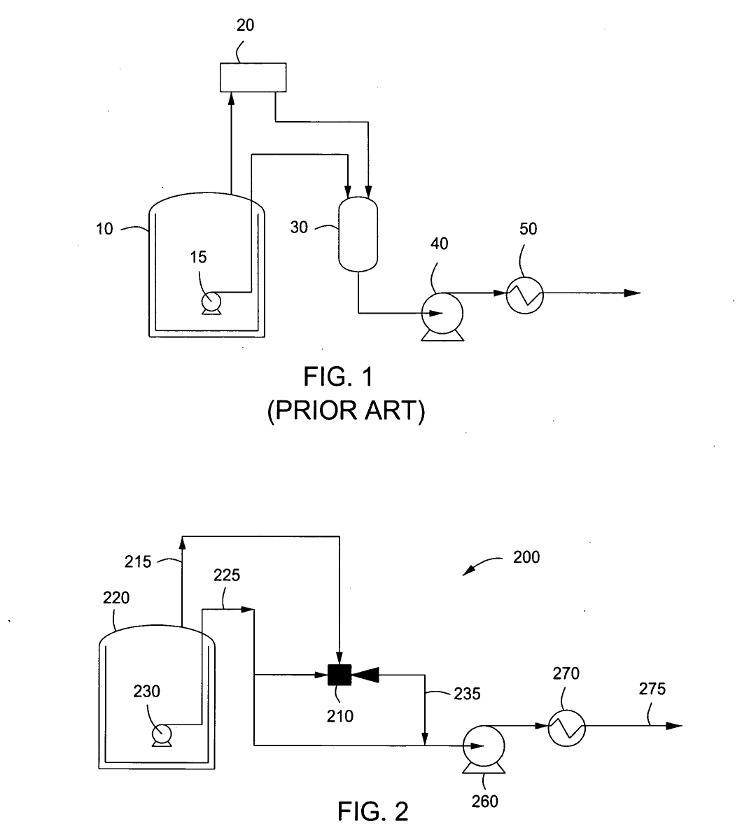

Referring to FIG. 1 and FIG. 2, the motive stream 225 can have a temperature ranging from a low of about −200° C., −180° C., −170° C. to a high of about −150° C., −140° C., or −130° C. In one or more embodiments, the motive stream 225 can have a temperature ranging of from about −168° C. to about −158° C. The pressure of the motive stream 225 can range from a low of about 100 kPa, 200 kPa, or 300 kPa to a high of about 1.3 MPa, 1.4 MPa, or 1.5 MPa. In one or more embodiments, the motive stream 225 can have a pressure ranging of from about 400 kPa to about 1.2 MPa. In one or more embodiments, the motive stream 225 can be adiabatically expanded through the high pressure nozzle 310 to about atmospheric pressure or a pressure less than that of the vapor stream 215.

The vapor stream 215 can have a temperature ranging from a low of about −200° C., −175° C., −150° C. to a high of about −125° C., −100° C., or −75° C. In one or more embodiments, the vapor stream 215 can have a temperature ranging from about −150° C. to about −130° C. The vapor stream 215 can have a pressure ranging from a low of about 90 kPa, 100 kPa, or 110 kPa to a high of about 130 kPa, 140 kPa, or 150 kPa. In one or more embodiments, the vapor stream 215 can have a pressure ranging of from about 120 kPa to about 125 kPa. In one or more embodiments, the vapor stream 215 has a temperature less than about −157° C. and a pressure less than about 960 kPa.

In one or more embodiments, the storage tank 220 can be above-ground. The storage tanks 220 can include a double-wall, high-nickel steel construction with efficient insulation between the walls. The storage tanks 220 can be vertical, horizontal, cylindrical or spherical. In one or more embodiments, the storage tanks 220 can include a domed roof or floating roof. In one or more embodiments, the storage tanks 220 can be underground. In one or more embodiments, hydrocarbon tanks can be portable.

In one or more embodiments, the in-tank pump 230 can be at least partially submerged within the liquefied gas stored in the storage tank 220. In one or more embodiments, the in-tank pump 230 can be completely submerged with the liquefied gas. Any pump capable of withstanding the cryogenic temperatures within the storage tank 220 and capable of producing the desired discharge pressure can be used. For example, the in-tank pump 230 can be a single stage pump or a multi-stage pump. Examples of suitable pumps include commercially available from J. C. Carter, Ebara, and Nikkiso.

In one or more embodiments, the discharge pressure of the in-tank pump 230 can range from a low of about 0.05 bar to a high of above about 15 bar. In one or more embodiments, the discharge pressure of the in-tank pump 230 can range from a low of about 1 bar to a high of above about 10 bar. In one or more embodiments, the discharge pressure of the in-tank pump 230 ranges from a low of about 0.05 bar, 1 bar, or 3 bar to a high of above about 5 bar, 10 bar, or 15 bar.

In operation, the motive stream 225 can be pumped from the storage tank 220 via the in-tank pump 230 to the eductor 210. The motive stream 225 can be expanded through the high pressure nozzle 310 to a pressure at or near atmospheric pressure. The expansion of motive stream 225 across the high pressure nozzle 310 can convert the pressure energy of the motive stream 225 into velocity energy, providing a low pressure zone within the mixing chamber 320. The vapor stream 215 (e.g. the BOG from the storage tank 220) can be drawn into the low pressure mixing chamber 320 where the BOG can be mixed with the expanded motive fluid. This mixed stream can be pressurized by conversion of velocity energy to pressure energy through the diverging zone 350. The mixture can then become liquid and routed via mixture stream 235 to the booster pump 260 and vaporized via vaporizer 270 prior to distribution via stream 275.

FIG. 4 depicts another illustrative system 400 for pressurizing a hydrocarbon with an eductor according to one or more embodiments. The system 460 can obtain higher efficiency in liquid-vapor compression than a system without a compressor (as shown in FIG. 2). The system 400 can include one or more compressors 240 (one shown) to compress the vapor stream 215 prior to the eductor 210. The compressor 240 can be used to compress the hydrocarbon within the vapor stream 215 to provide a compressed vapor stream 417. The vapor compression of the compressor 240 can be less than conventional BOG compression.

Referring to FIG. 3 and FIG. 4, the motive fluid 225 can be adiabatically expanded through a high pressure nozzle 310 of an eductor 210 to a slightly lower pressure than the vapor stream 417 suction pressure. The motive stream 225 pressure energy can convert into velocity energy across the high pressure nozzle 310 of the eductor 210. In one or more embodiments, the motive fluid 225 can remain in a sub-cooled liquid phase in the mixing chamber 320 of the eductor 210 for operating conditions suitable for the system 400. The vapor can be mixed with the motive in the mixing chamber 320 of the eductor 210. The pressure of the mixed stream can increase as the mixed stream passes through the diverging zone 350 of the eductor 210 as the mixture velocity energy converts into pressure energy.

In one or more embodiments, the pressure of the compressed vapor stream 417 can be about 150 kPa or more. In one or more embodiment, the pressure of the compressed vapor stream 417 can be about 1 MPa or more.

FIG. 5 depicts yet another illustrative system 500 for pressurizing a hydrocarbon with two or more eductors according to one or more embodiments. In one or more embodiments, the system 500 can include two or more eductors 210 arranged in parallel or series. For example, two eductors 210 (first eductor and second eductor) can be arranged in series as depicted.

The motive stream 225 can be split or otherwise apportioned to two or more streams 226, 227. The motive stream 225 can be a high pressure stream of about 40 barg or more. The hydrocarbon from the vapor stream 215 (e.g. the BOG from the storage tank 220) can be drawn into the first eductor 210 and mixed with the expanded motive fluid from stream 226. Referring to FIGS. 3 and 5, the mixed stream pressure increases through the diverging zone 350 of the first eductor 210, providing a resulting mixed liquid stream 235. The pressure of the mixed liquid stream 235 can be of from about 3 barg to about 30 barg.

In one or more embodiments, the mixed liquid stream 235 can become the suction fluid to the second eductor 210. The motive fluid from stream 227 can flow through the high pressure nozzle 310 into the mixing chamber 320 of the second eductor 210. As a result, the motive fluid velocity increases and the pressure decreases, adiabatically expanding the motive stream across the high pressure nozzle. As a the resulting pressure decrease within the mixing chamber 320 occurs, the second eductor 210 suctions the mixed liquid stream 235 into the mixing chamber 320 of the second eductor 210 where the suctioned hydrocarbon can be mixed with the high velocity motive fluid. While the mixed stream flows through the diverging zone 350 of the second eductor 210, the pressure of the mixed stream can increase to provide a high pressure mixed stream 535. The high pressure mixed stream 535 can be lower in pressure than the original high pressure motive stream 225.

The mixed stream 535 can be vaporized using the vaporizer 270, and can be sent to distribution or use via stream 275. The mixed stream 535 can have a pressure sufficient to eliminate the pump 260 (shown in FIGS. 2 and 4). For example, the mixed stream 535 can have a pressure of from about 10 barg to about 80 barg. In one or more embodiments, the mixed stream 535 can provide a suction fluid or motive fluid to a third or subsequent eductor. In one or more embodiments, the pressure of the mixed stream 535 can depend on pressures of vapor stream 215 and motive stream 225.

Specific embodiments can further include methods for pressurizing vapor from a liquefied gas comprising: flowing at least a portion of a storage tank overhead vapor stream to an eductor; flowing at least a portion of a hydrocarbon liquid stream to the eductor, the hydrocarbon liquid stream having a higher pressure than the vapor stream; combining the vapor stream and the hydrocarbon liquid stream within the eductor to provide a mixed stream; and pressurizing the mixed stream within the eductor.

Specific embodiments can further include the methods of paragraph [0034] and one or more of the following embodiments: wherein the overhead vapor stream is suctioned to the eductor using energy from an adiabatic expansion of the hydrocarbon liquid stream within the eductor; wherein the overhead vapor stream comprises a boil off gas from the storage tank; wherein the hydrocarbon liquid stream comprises a liquefied gas from the storage tank; further comprising pumping the hydrocarbon liquid stream from the storage tank using an in-tank pump disposed within the storage tank; further comprising compressing the boil off gas prior to suctioning the gas to the eductor; and/or wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof.

Specific embodiments can further include methods for pressurizing vapor from a liquefied gas comprising: flowing a lower pressure hydrocarbon stream from one or more storage tanks to an eductor, the lower pressure hydrocarbon stream comprising a boil off gas from one or more liquefied gases; using energy from a higher pressure hydrocarbon stream from the storage tank to suction the lower pressure hydrocarbon stream into the eductor; condensing the boil off gas within the eductor to provide a liquid hydrocarbon stream; and pressurizing the liquid hydrocarbon stream within the eductor.

Specific embodiments can further include the methods of paragraph [0036] and one or more of the following embodiments: wherein the higher pressure hydrocarbon stream comprises the liquefied gas; wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof; wherein the liquefied gas comprises liquefied natural gas; and/or further including compressing the boil off gas prior to suctioning the gas to eductor.

Specific embodiments can further include methods for pressurizing vapor from a liquefied gas comprising: flowing a lower pressure hydrocarbon stream from one or more storage tanks to a first eductor, the lower pressure hydrocarbon stream comprising a boil off gas from one or more liquefied gases; using energy from a higher pressure hydrocarbon stream from the storage tank to suction the lower pressure hydrocarbon stream into the first eductor; condensing the boil off gas within the first eductor to provide a first mixed hydrocarbon stream; suctioning at least a portion of the first mixed hydrocarbon stream to a second eductor using energy from the higher pressure hydrocarbon stream from the storage tank to provide a second mixed hydrocarbon stream; and pressurizing the second mixed hydrocarbon stream within the second eductor.

Specific embodiments can further include the methods of paragraph [0038] and one or more of the following embodiments: wherein the higher pressure hydrocarbon stream comprises the liquefied gas; wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof; wherein the liquefied gas comprises liquefied natural gas; and/or further including compressing the boil off gas prior to suctioning the gas to the first eductor.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments, other and further embodiments may be devised without departing from the basic scope thereof, and the scope thereof is determined by the claims that follow.

What is claimed is:

1) A method for pressurizing vapor from a liquefied gas comprising:
flowing at least a portion of a storage tank overhead vapor stream to an eductor;
flowing at least a portion of a hydrocarbon liquid stream to the eductor, the hydrocarbon liquid stream having a higher pressure than the vapor stream;
combining the vapor stream and the hydrocarbon liquid stream within the eductor to provide a mixed stream; and
pressurizing the mixed stream within the eductor.

2) The method of claim 1, wherein the overhead vapor stream is suctioned to the eductor using energy from an adiabatic expansion of the hydrocarbon liquid stream within the eductor.

3) The method of claim 1, wherein the overhead vapor stream comprises a boil off gas from the storage tank.

4) The method of claim 1, wherein the hydrocarbon liquid stream comprises a liquefied gas from the storage tank.

5) The method of claim 1, further comprising pumping the hydrocarbon liquid stream from the storage tank using an in-tank pump disposed within the storage tank.

6) The method of claim 1, further comprising compressing the boil off gas prior to suctioning the gas to the eductor.

7) The method of claim 1, wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof.

8) A method for pressurizing vapor from a liquefied gas comprising:
flowing a lower pressure hydrocarbon stream from one or more storage tanks to an eductor, the lower pressure hydrocarbon stream comprising a boil off gas from one or more liquefied gases;
using energy from a higher pressure hydrocarbon stream from the storage tank to suction the lower pressure hydrocarbon stream into the eductor;
condensing the boil off gas within the eductor to provide a liquid hydrocarbon stream; and
pressurizing the liquid hydrocarbon stream within the eductor.

9) The method of claim 8, further comprising compressing the boil off gas prior to suctioning the gas to eductor.

10) The method of claim 8, wherein the higher pressure hydrocarbon stream comprises the liquefied gas.

11) The method of claim 10, wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof.

12) The method of claim 10, wherein the liquefied gas comprises liquefied natural gas.

13) A method for pressurizing vapor from a liquefied gas comprising:
flowing a lower pressure hydrocarbon stream from one or more storage tanks to a first eductor, the lower pressure hydrocarbon stream comprising a boil off gas from one or more liquefied gases;
using energy from a higher pressure hydrocarbon stream from the storage tank to suction the lower pressure hydrocarbon stream into the first eductor;
condensing the boil off gas within the first eductor to provide a first mixed hydrocarbon stream;
suctioning at least a portion of the first mixed hydrocarbon stream to a second eductor using energy from the higher pressure hydrocarbon stream from the storage tank to provide a second mixed hydrocarbon stream; and
pressurizing the second mixed hydrocarbon stream within the second eductor.

14) The method of claim 13, further comprising compressing the boil off gas prior to suctioning the gas to the first eductor.

15) The method of claim 13, wherein the higher pressure hydrocarbon stream comprises the liquefied gas.

16) The method of claim 15, wherein the liquefied gas is selected from the group consisting of liquefied natural gas (LNG), liquefied petroleum gas (LPG), liquefied energy gas (LEG), liquefied ethylene, natural gas liquid, liquefied methane, liquefied propane, liquefied butane, liquefied ammonia, combinations thereof and derivatives thereof.

17) The method of claim 15, wherein the liquefied gas comprises liquefied natural gas.
